(19) United States
(12) Patent Application Publication
(10) Pub. No.: US 2014/0012975 A1
(43) Pub. Date: Jan. 9, 2014

(54) COMPUTER CLUSTER, MANAGEMENT METHOD AND MANAGEMENT SYSTEM FOR THE SAME

(71) Applicants: Ming-Jen WANG, Taichung City (TW); Li-Chieh YU, Hsinchu (TW); Chuan-Lin LAI, Hsinchu (TW); Chia-Chen KUO, Hsinchu (TW); Hsi-Ya CHANG, Hsinchu (TW)

(72) Inventors: Ming-Jen WANG, Taichung City (TW); Li-Chieh YU, Hsinchu (TW); Chuan-Lin LAI, Hsinchu (TW); Chia-Chen KUO, Hsinchu (TW); Hsi-Ya CHANG, Hsinchu (TW)

(73) Assignee: NATIONAL APPLIED RESEARCH LABORATORIES, Taipei (TW)

(21) Appl. No.: 13/544,091

(22) Filed: Jul. 9, 2012

(51) Int. Cl. G06F 15/173

(52) U.S. Cl. 709/224

(57) ABSTRACT

A computer cluster includes a node and a management system. The node includes an agent and generates a node event message in response to occurrence of an event. The agent gathers a software behavior information set, and generates a node information set when the node generates the node event message. The management system is configured to communicate with the node and includes a database storing at least one pre-established solution information set, and an agent management module configured to search the database according to the node information set. Upon finding a solution information set from the database, the agent management module sends the solution information set to the node so that the agent generates a solution for the event.

### BACKGROUND OF THE INVENTION

1. Field of the Invention

The invention relates to a computer cluster, a management method and a management system for the computer cluster.

2. Description of the Related Art

A render farm is a computer cluster designed for rendering computer-generated imagery (CGI). Recent advancement in computing power of the render frame allows efficient production of relatively more complicated and realistic images, such as 3D images in blockbuster movies. Specifically, in a render farm, a large number of computers (each being referred to as a node) are configured to cooperatively execute the image rendering task, with each node being assigned a particular function such as a cluster supervisor, a license server, a computing engine, etc.

Since each node is assigned a function that differs from others, configurations of hardware and software are different among the nodes. As a result, when a particular node malfunctions, finding the solution for the particular node efficiently is important.

In U.S. Patent Application Publication No. 2008/0046708 A1, entitled “System and Method for Management and Installation of Operating System Images for Computers”, there is disclosed a conventional system for provisioning an operating system on target computers over a network. The conventional system includes at least one target computer, at least one operating system management server and a policy store that stores policy data.

The target computer includes a client agent. The policy data defines an association between a specific criteria data instance and an operating system image instance.

The client agent is operable to gather policy criteria data (i.e., configuration data) and to transmit the same to the operating system management server. The operating system management server is operable to search the policy store according to the policy criteria data from the target computer. When the operating system management server finds a pre-existing operating system image corresponding to the policy criteria data, it is operable to obtain the operating system image and to install the same to the target computer. The policy criteria data includes at least one of hardware configuration data and user-input data (e.g., a user identifier).

This conventional system can be applied to address malfunctioning of a particular node of the computer cluster. Specifically, the operating system management server is operable to detect a malfunctioning node according to the hardware configuration data of the policy criteria data, and to obtain the operating system image that corresponds to the malfunctioning node, such that the malfunctioning node can be recovered to the previous functional state. However, a generally applicable solution other than simply reinstalling the operating system image is preferable.

### SUMMARY OF THE INVENTION

Therefore, the object of the present invention is to provide a computer cluster that is configured to address the aforementioned issue.

Accordingly, a computer cluster of the present invention comprises at least one node and a management system.

The node includes an agent, corresponds to a predetermined node function information set relating to a function of the node, and generates a node event message in response to occurrence of an event. The agent is configured to gather a software behavior information set of the node, and to generate a node information set that includes the node function information set, the software behavior information set and the node event message when the node generates the node event message.

The management system is configured to communicate with the node, and includes a database and an agent management module. The database stores at least one pre-established solution information set. The agent management module is configured to search the database according to the node information set. Upon finding the solution information set that is related to the node information set from the database, the agent management module is configured to send the solution information set to the node so that the agent generates a solution, which includes at least one program instruction executable by the node, for the event of the node event message according to the solution information set together with the node function information set.

Another object of this invention is to provide a management system for the computer cluster.

Accordingly, a management system of this invention is for use with at least one node. The node includes an agent, corresponds to a predetermined node function information set relating to a function of the node, and generates anode event message in response to occurrence of an event. The agent is configured to gather a software behavior information set of the node, and to generate a node information set that includes the node function information set, the software behavior information set and the node event message when the node generates the node event message. The management system is configured to communicate with the node and comprises a database and an agent management module.

The database stores at least one pre-established solution information set. The agent management module is configured to search the database according to the node information set, and upon finding the solution information set that is related to the node information set from the database, to send the solution information set to the node to allow the agent to generate a solution, which includes at least one program instruction executable by the node, for the event of the node event message according to the solution information set together with the node function information set.

Still another object of this invention is to provide a management method for the computer cluster.

Accordingly, a management method of this invention is to be implemented using the computer cluster. The computer cluster includes at least one node that corresponds to a predetermined node function information set relating to a function of the node, and a management system that is operable to communicate with the node and that includes a database storing at least one pre-established solution information set. The management method comprises the following steps of:

configuring the node to gather a software behavior information set thereof;

when the node generates a node event message in response to occurrence of an event, configuring the node to generate a node information set that includes the node function information set, the software behavior information set and the node event message;

configuring the management system to search the database according to the node information set;

upon finding the solution information set that is related to the node information set from the database, configuring the management system to send the solution information set to the node; and

configuring the node to generate a solution, which includes at least one program instruction executable by the node, for the event of the node event message according to the solution information set together with the node function information set.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram of a preferred embodiment of a computer cluster according to this invention;

FIG. 2 is a flow chart of the embodiment of a management method for the computer cluster, according to this invention; and

FIG. 3 is a flow chart illustrating a procedure of the management method for searching a database of the computer cluster.

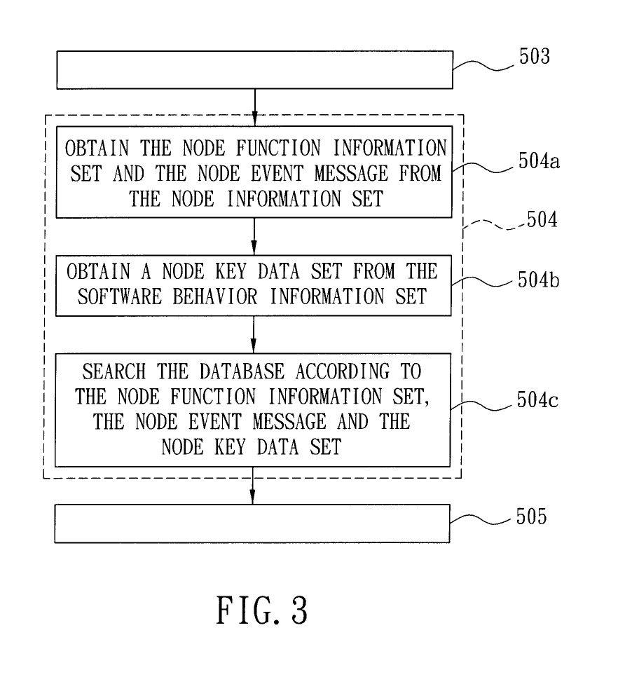

### DETAILED DESCRIPTION OF THE PREFERRED EMBODIMENT

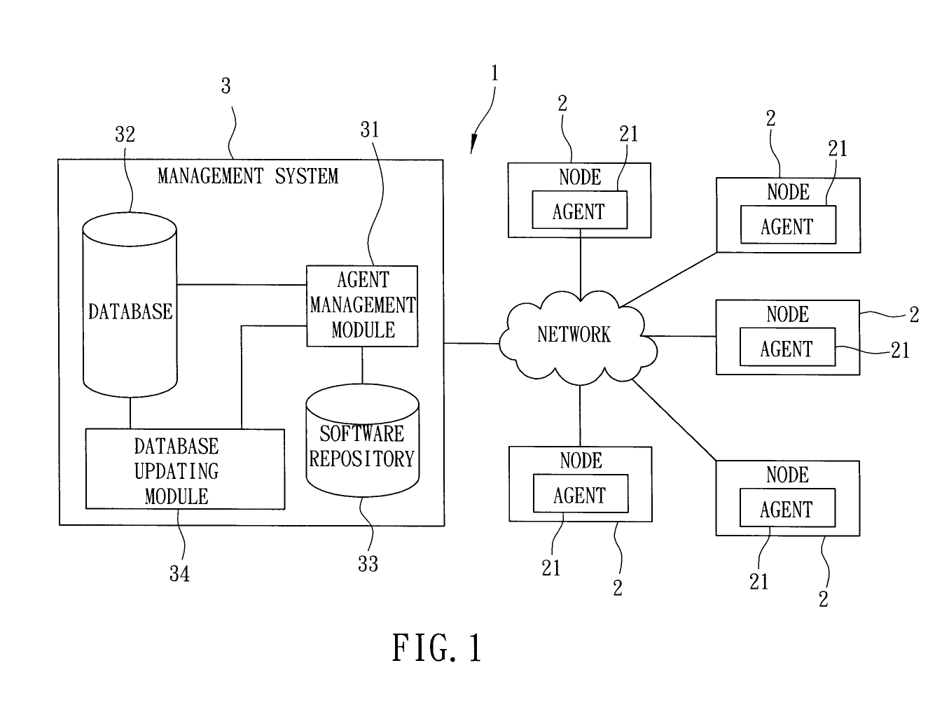

As shown in FIG. 1, the preferred embodiment of a computer cluster 1 according to the present invention comprises a plurality of nodes 2 and a management system 3. Each of the nodes 2 includes an agent 21 and corresponds to a predetermined node function information set relating to a function of the node 2. In this embodiment, each of the nodes 2 is a computer, and the agent 21 is a software program installed in each of the nodes 2. The management system 3 is configured to communicate with the nodes 2 over a network (e.g., Internet or Intranet), and includes an agent management module 31, a database 32 coupled to the agent management module 31, a software repository 33 coupled to the agent management module 31, and a database updating module 34 coupled to the agent management module 31 and the database 32. The database 32 stores at least one pre-established solution information set.

As an example, the computer cluster 1 may be a render farm, one of the nodes 2 may be assigned as a render supervisor, while the remaining nodes 2 may be assigned as render workers. The render supervisor is operable to dispatch different tasks to the render workers. The management system 3 is operable to manage software environment of the nodes 2, for example, constructing, recovering and repairing the environment of the nodes 2.

For each of the nodes 2, the agent 21 is configured to gather a software behavior information set and a hardware configuration information set of the corresponding node 2. When an event related to the node 2 occurs, the node 2 is operable to generate a node event message, and the agent 21 is operable to generate a node information set that includes the node function information set, the software behavior information set and the node event message, and to transmit the node information set to the management system 3.

Upon receipt of the node information set, the agent management module 31 of the management system 3 is configured to search the database 32 according to the node information set. When the agent management module 31 finds the solution information set, which is related to the node information set, from the database 32, the solution information set thus found is subsequently sent to the node 2, so that the agent 21 is operable to generate a solution thereupon. In this embodiment, the solution includes at least one program instruction executable by the node 2, is for the event of the node event message, and is generated according to the solution information set together with the node function information set. It is noted that, when the solution information set is related to hardware status of the node 2, the agent 21 of the node 2 is further configured to gather a hardware configuration information set of the node 2, and to generate the solution according to the solution information set together with the node function information set and the hardware configuration information set.

On the other hand, when the agent management module 31 fails to find a proper solution information set from the database 32, the database updating module 34 is configured to provide a user interface for allowing a user (e.g., an administrator) to establish a solution information set related to the node information set for the event of the node event message, and to store the solution information set thus established in the database 32.

The succeeding paragraphs are directed to a management method for the computer cluster 1 according to the preferred embodiment of this invention, for a more detailed illustration of interactions between the nodes 2 and the agents 21. It is noted that, since interactions between each of the nodes 2 and respective one of the agents 21 are similarly configured, only one node 2 and an agent 21 thereof will be described in the following.

Before the method is implemented, the agent 21 has to be installed in the node 2. The installation procedure is executed as de scribed below. During the installation, the user is required to manually input a software/hardware environment setting (e.g., components needed to be installed in the node 2, the setting data related to a firewall and to a network). After the input of the software/hardware environment setting is completed (indicated by, for example, pushing a confirmation button), the node 2 is operable to generate the node event message. The agent 21 is in turn operable to generate and to transmit the node information set to the management system 3, which is operable to transmit the solution information set back to the node 2 based on the node information set. In this example, the solution information set includes a program instruction for initial installation. The agent 21 is operable to generate the solution to be executed by the node 2, and the solution includes a string of software instructions, a string of installation paths associated with the string of software instructions, and a set of software/hardware environment setting values.

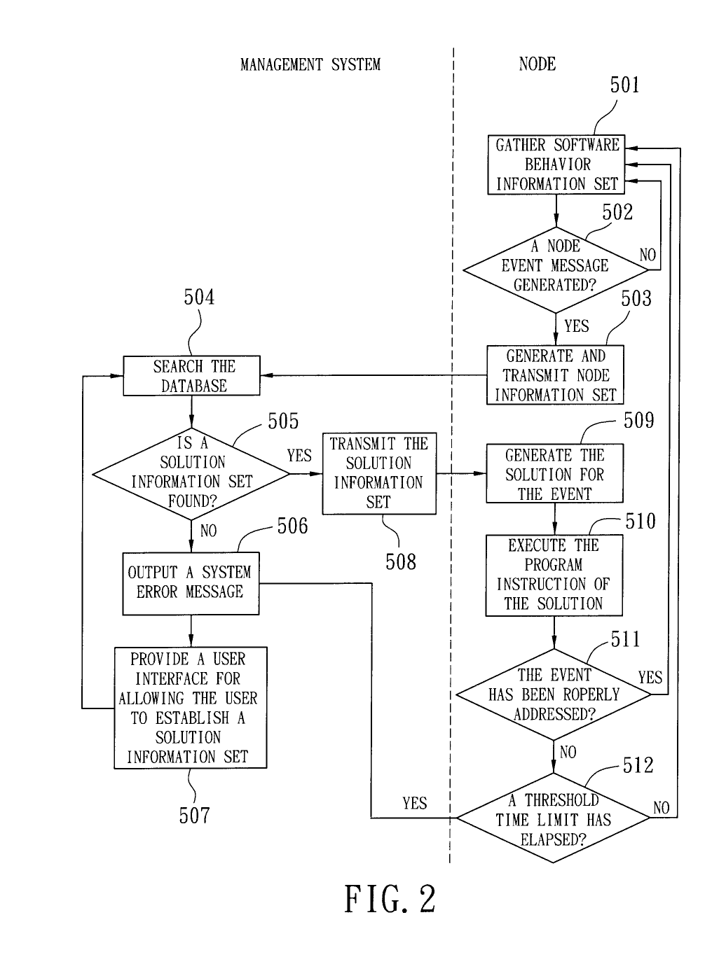

Referring to FIG. 2, steps of the method are now described in the following.

In step 501, the agent 21 of the node 2 is operable to gather the software behavior information set and the hardware configuration information set of the node 2 based on the node function information set and the software/hardware environment setting of the node 2. Specifically, the software behavior information set indicates the status of the software that is installed in the node 2.

In step 502, the agent 21 is operable to determine whether a node event message is generated. When the node event message is generated, the flow goes to step 503. Otherwise, the step goes back to step 501.

The note event message is generated in response to occurrence of some specific events, for example complete input of the software/hardware environment setting, an error during operation of the node 2, receipt of a request for a monitor software state from a foreign client computer, etc.

Then, in step 503, the agent 21 of the node 2 is operable to generate the node information set that includes the node function information set, the software behavior information set and the node event message, and to transmit the node information set to the management system 3.

In step 504, the agent management module 31 of the management system 3 is operable to search the database 32 for the pre-established solution information set that is related to the node information set received from the agent 21.

In this embodiment, the database 32 stores at least one criterion, at least one solution information set and relationship between the criterion and the solution information set. The criterion stored in the database 32 includes a pre-established function information set, a pre-established event message and a pre-established key data set. The agent management module 31 is operable to obtain a set of query condition from the node information set, and to search the database 32 according to the query condition. Particularly, step 504 includes the following sub-steps.

The agent management module 31 of the management system 3 is operable to obtain the node function information set and the node event message from the node information set in sub-step 504a, and to obtain a node key data set from the software behavior information set according to at least one of the node function information set and the node event message in sub-step 504b. Subsequently, in sub-step 504c, the agent management module 31 of the management system 3 is operable to search the database 32 according to the node function information set, the node event message and the node key data set serving as the query condition.

Afterward, in step 505, the agent management module 31 is operable to determine whether the pre-established solution information set, which is related to the node information set, is found in step 504. Specifically, when the agent management module 31 of the management system 3 finds the criterion that conforms with the query condition from the database 32, the solution information set related to the criterion that corresponds to the query condition is selected by the agent management module 31. The flow goes to step 508 when the solution information set is found, and goes to step 506 when otherwise.

In step 506, the agent management module 31 is operable to output a system error message to notify the user. Then, in step 507, the database updating module 34 of the management system 3 is operable to provide a user interface for allowing the user to establish a solution information set related to the node information set for the event of the node event message. Afterward, the flow goes back to step 504. In other embodiments, the flow may go to step 508 directly.

In step 508, the agent management module 31 transmits the solution information set (found in the database 32 or established by the user) to the node 2. The solution information set may further include a software access path that is linked to software stored in the software repository 33, in the case where the software stored in the software repository 33 is needed for the event.

In step 509, the agent 21 of the node 2 is operable to generate the solution for the event of the node event message according to the solution information set together with the node function information set. When the solution information set is related to the hardware of the node 2, the agent 21 is operable to generate the solution by further incorporating the hardware environment configuration information set. The solution includes at least one program instruction executable by the node 2.

As an example, the solution information set may instruct the node 2 to install a driver that is associated with a specific hardware. Subsequently, the solution includes a string of program instructions needed to install the driver of the specific hardware, and a set of software/hardware setting values related to the program instructions. Since, each node 2 of the computer cluster 1 is assigned a function different from the functions of other nodes, the solution must be customized for the node 2.

Then, in step 510, the node 2 is operable to execute the program instruction of the solution generated in step 509.

The agent 21 of the node 2 is operable to verify whether the event related to the node 2 has been properly addressed in step 511. When the verification is affirmative, the flow goes back to step 501 to continue monitoring the status of the computer cluster 1. Otherwise, the flow goes to step 512, in which the agent 21 determines whether a threshold time limit has elapsed for processing the node event message. When the threshold time limit has not yet elapsed, the flow goes back to step 501. Otherwise, the step goes to step 506.

To sum up, the computer cluster 1 of this invention incorporates an agent 21 in each of the nodes 2, such that occurrence of an event related to any one of the nodes 2 can be handled by the management system 3 so as to provide a solution to address the event.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A computer cluster comprising:
at least one node including an agent, corresponding to a predetermined node function information set relating to a function of said node, and generating a node event message in response to occurrence of an event, said agent being configured to gather a software behavior information set of said node, and to generate a node information set that includes the node function information set, the software behavior information set and the node event message when said node generates the node event message; and
a management system configured to communicate with said node and including
a database storing at least one pre-established solution information set, and
an agent management module configured to search said database according to the node information set, and upon finding the solution information set that is related to the node information set from said database, to send the solution information set to said node so that said agent generates a solution, which includes at least one program instruction executable by said node, for the event of the node event message according to the solution information set together with the node function information set.

2. The computer cluster as claimed in claim 1, wherein said agent of said node is further configured to gather a hardware configuration information set of said node, and to generate the solution according to the solution information set together with the node function information set and the hardware configuration information set.

3. The computer cluster as claimed in claim 2, wherein said agent of said node is configured to gather the software behavior information set and the hardware configuration information set according to the node function information set and a software/hardware environment setting.

4. The computer cluster as claimed in claim 1, wherein said database of said management system further stores at least one criterion and relationship between the criterion and the solution information set.

5. The computer cluster as claimed in claim 4, wherein said agent management module of said management system is configured to obtain a query condition from the node information set, to search said database according to the query condition, to find the criterion that conforms with the query condition from said database, and to send the solution information set related to the criterion that conforms with the query condition.

6. The computer cluster as claimed in claim 5, wherein the criterion stored in said database includes a pre-established function information set, a pre-established event message and a pre-established key data set, and said agent management module is configured to:
obtain the node function information set and the node event message from the node information set;
obtain a node key data set from the software behavior information set according to at least one of the node function information set and the node event message;
search said database according to the node function information set, the node event message and the node key data set serving as the query condition; and
send the solution information set related to the criterion including the pre-established function information set, the pre-established event message and the pre-established key data set that conform with the node function information set, the node event message and the node key data set, respectively.

7. The computer cluster as claimed in claim 1, wherein said management system further includes a database updating module that is configured to provide a user interface for allowing a user to establish a solution information set related to the node information set for the event of the node event message when said agent management module fails to find the pre-established solution information set related to the node information set from said database.

8. A management system for a computer cluster including at least one node, the node including an agent, corresponding to a predetermined node function information set relating to a function of the node, and generating a node event message in response to occurrence of an event, the agent being configured to gather a software behavior information set of the node, and to generate a node information set that includes the node function information set, the software behavior information set and the node event message when the node generates the node event message, said management system being configured to communicate with the node and comprising:
a database storing at least one pre-established solution information set; and
an agent management module configured to search said database according to the node information set, and upon finding the solution information set that is related to the node information set from said database, to send the solution information set to the node to allow the agent to generate a solution, which includes at least one program instruction executable by the node, for the event of the node event message according to the solution information set together with the node function information set.

9. The management system as claimed in claim 8, wherein said database further stores at least one criterion and relationship between the criterion and the solution information set.

10. The management system as claimed in claim 9, wherein said agent management module is configured to obtain a query condition from the node information set, to search said database according to the query condition, to find the criterion that conforms with the query condition from said database, and to send the solution information set related to the criterion that conforms with the query condition.

11. The management system as claimed in claim 10, wherein the criterion stored in said database includes a pre-established function information set, a pre-established event message and a pre-established key data set, and said agent management module is configured to:
obtain the node function information set and the node event message from the node information set;
obtain a node key data set from the software behavior information set according to at least one of the node function information set and the node event message;
search said database according to the node function information set, the node event message and the node key data set serving as the query condition; and
send the solution information set related to the criterion including the pre-established function information set, the pre-established event message and the pre-established key data set that conform with the node function information set, the node event message and the node key data set, respectively.

12. The management system as claimed in claim 8, further comprising a database updating module that is configured to provide a user interface for allowing a user to establish a solution information set related to the node information set for the event of the node event message when said agent management module fails to find the pre-established solution information set related to the node information set from said database.

13. A management method for a computer cluster, the computer cluster including at least one node that corresponds to a predetermined node function information set relating to a function of the node, and a management system that is operable to communicate with the node and that includes a database storing at least one pre-established solution information set, said management method to be implemented using the computer cluster and comprising the following steps of:
a) configuring the node to gather a software behavior information set thereof;
b) when the node generates a node event message in response to occurrence of an event, configuring the node to generate a node information set that includes the node function information set, the software behavior information set and the node event message;
c) configuring the management system to search the database according to the node information set;
d) upon finding the solution information set that is related to the node information set from the database, configuring the management system to send the solution information set to the node; and
e) configuring the node to generate a solution, which includes at least one program instruction executable by the node, for the event of the node event message according to the solution information set together with the node function information set.

14. The management method as claimed in claim 13, wherein:
in step a), the node is further configured to gather a hardware configuration information set of the node; and
in step e), the node is configured to generate the solution according to the solution information set together with the node function information set and the hardware configuration information set.

15. The management method as claimed in claim 14, wherein, in step a), the node is configured to gather the software behavior information set and the hardware configuration information set according to the node function information set and a software/hardware environment setting.

16. The management method as claimed in claim 13, the database further storing at least one criterion and relationship between the criterion and the solution information set,
wherein, in step c), the management system is configured to obtain a query condition from the node information set, and to search the database according to the query condition;
wherein, in step d), the management system is configured to find the criterion that conforms with the query condition from the database, and to send the solution information set related to the criterion that conforms with the query condition.

17. The management method as claimed in claim 16, the criterion stored in the database including a pre-established function information set, a pre-established event message and a pre-established key data set, wherein step c) includes the sub-steps of:
c1) configuring the management system to obtain the node function information set and the node event message from the node information set;
c2) configuring the management system to obtain a node key data set from the software behavior information set according to at least one of the node function information set and the node event message; and
c3) configuring the management system to search the database according to the node function information set, the node event message and the node key data set serving as the query condition;
wherein, in step d), the management system is configured to send the solution information set related to the criterion including the pre-established function information set, the pre-established event message and the pre-established key data set that conform with the node function information set, the node event message and the node key data set, respectively.

18. The management method as claimed in claim 13, further comprising, after step c), the step of:
when the management system fails to find the pre-established solution information set related to the node information set from the database, configuring the management system to provide a user interface for allowing a user to establish a solution information set related to the node information set for the event of the node event message.
